(19) United States
(12) Patent Application Publication
(10) Pub. No.: US 2023/0257249 A1
(43) Pub. Date: Aug. 17, 2023

(54) LIQUID DISPENSER APPARATUS

(71) Applicant: UNITO SMART TECHNOLOGIES LIMITED, Tsuen Wan NT (HK)

(72) Inventors: Abraham DAHAN, Rishon LeTzion (IL); Yuval-Yoni DAHAN, Rishon LeTzion (IL)

(73) Assignee: UNITO SMART TECHNOLOGIES LIMITED, Tsuen Wan NT (HK)

(21) Appl. No.: 18/105,517

(22) Filed: Feb. 3, 2023

(30) Foreign Application Priority Data
Feb. 11, 2022 (EP) 22156370.3

(51) Int. Cl. B67D 1/00; E03C 1/044

(52) U.S. Cl. CPC B67D 1/004; B67D 1/0034; B67D 1/0058; B67D 1/0074; E03C 1/044; E03C 2201/45

(57) ABSTRACT

An apparatus for dispensing liquid comprising: a base structure having a liquid inlet configured to receive a liquid from a liquid source, a gas inlet configured to receive gas from a gas source, a dispensing outlet connected to a liquid dispensing unit, a storage connecting portion connected to a liquid storage, and a passage arrangement configured to put at least two of the liquid inlet, the gas inlet, the dispensing outlet and the storage connecting portion into fluid communication with each other. The apparatus further comprises a valve arrangement seated in the base structure and configured to control fluid passage of the liquid inlet, the gas inlet, the dispensing outlet, and/or the storage connecting portion. The apparatus further comprises a control unit having at least one signal input configured to be connected to a user interface, and at least one signal output configured to control the valve arrangement.

The present invention refers to a liquid dispenser apparatus.

Liquid dispenser apparatuses of the above type are generally known and are often used for dispensing treated or non-treated liquids, such as filtered or non-filtered hot or cold water or beverages, in particular in conjunction with household applications, such as faucets of kitchens or the like. However, already at this point it should be noted that although the present invention is described below in part with reference to the dispensing of water and beverages via faucets of kitchens, no limitations of the invention can be derived therefrom.

Typical liquid dispenser apparatuses comprise at least one liquid inlet which is designed and intended to be connected to a liquid source, such as a mains water supply, and to receive liquid from the liquid source, and at least one liquid outlet which is connected to a liquid dispensing unit, such as a faucet. Additionally, to be also able to deliver treated liquid, such as carbonated water and/or water treated with additives, said liquid dispenser apparatuses may also comprise a gas inlet which is designed and intended to be connected to a gas source and configured to receive gas, in particular CO₂ gas, from the gas source, and a further inlet which is designed and intended to be connected to an additive source, such as an additive storage.

To provide the above functions, known liquid dispenser apparatuses often comprise a variety of spatially separated liquid storages that are connected via a corresponding variety of liquid passages in form of liquid lines, and one or more manifolds to allow suitable fluid communication between the above described components. Thus, said liquid dispenser apparatuses usually have a high number of liquid containing and liquid guiding components that have to be sealed against potential leakage to the outside of the liquid dispenser apparatus. The same applies for each transition or connection point of one component of the liquid dispenser apparatus to another component of the liquid dispenser apparatus. As a result, known liquid dispenser apparatuses show a relatively high leakage risk, as there is a high number of separate components that are susceptible to potential leakage. Considering the case in which such liquid dispenser apparatuses are stored in a kitchen, for example, the damage caused by the liquid leakage may be destructive for the kitchen.

Furthermore, the high number of spatially separated but fluidically connected components of known liquid dispenser apparatuses often leads to complicate and time consuming assembly and/or maintenance, a high risk for assembly mistakes as well as to a non-compact design which results in comparatively high installation space.

It is therefore an object of the present invention to provide a liquid dispenser apparatus which is capable to counter at least some of the above-mentioned drawbacks.

According to the present invention this object is solved by a liquid dispenser apparatus, comprising a base structure having a liquid inlet which is designed and intended to be connected to a liquid source and to receive a liquid from the liquid source, a gas inlet which is designed and intended to be connected to a gas source and configured to receive gas from the gas source, a dispensing outlet which is designed and intended to be connected to a liquid dispensing unit, in particular a faucet, a storage connecting portion which is designed and intended to be connected to a liquid storage, and a passage arrangement which is configured to put at least two of the liquid inlet, the gas inlet, the dispensing outlet and the storage connecting portion into fluid communication with each other, wherein the liquid dispenser apparatus further comprises: a valve arrangement which is seated in the base structure and configured to control a fluid passage of the liquid inlet and/or the gas inlet and/or the dispensing outlet and/or the storage connecting portion, and a control unit having at least one signal input which is configured to be connected to a user interface, and at least one signal output which is configured to be connected to the valve arrangement such that the valve arrangement is controlled by the at least one signal output, wherein the base structure of the liquid dispenser apparatus is formed by a molded structure or by a machined structure.

According to the present invention the base structure, which is formed by the molded structure or by the machined structure, has the liquid inlet, the gas inlet, the dispensing outlet, the storage connecting portion and the passage arrangement which is configured to put at least two of the liquid inlet, the gas inlet, the dispensing outlet and the storage connecting portion into fluid communication with each other. Thus, as all of the above elements are part of the base structure, the number of separate components that have to be sealed against potential leakage is significantly reduced. As a result, the number of connection pipes and fittings can also be minimized. Furthermore, in contrast to prior art liquid dispenser apparatuses, it is not necessarily required to employ a separate manifold, as the passage arrangement provides an internal fluid communication network for at least two of the liquid inlet, the gas inlet, the dispensing outlet and the storage connecting portion. It should be noted that the passages of the passage arrangement may be formed by the base structure itself or by a number of pipes, such as metal or plastic pipes, that are embedded in the molded base structure.

According to the invention, the valve arrangement for controlling the fluid passage of the liquid inlet and/or the gas inlet and/or the dispensing outlet and/or the storage connecting portion is also seated in the base structure so that the liquid dispenser apparatus shows a particular compact design. Such compact design is not only advantageous with regard to the required installation space but also shortens the time which is required for assembly of the apparatus and/or for potential maintenance measures.

In principle the base structure may be formed by any molding method which is suitable to provide a molded part constituting the base structure or by a suitable machining method, such as CNC machining, in particular CNC milling, which is suitable to provide a machined part constituting the base structure.

However, to be able to produce the liquid dispenser apparatus in large quantities with high quality at comparatively low costs, according to an embodiment of the invention it is preferred that the base structure of the liquid dispenser apparatus is formed by an injection molded structure.

As an alternative, to be also able to provide a wide variety of different designs and/or shapes and/or dimensions of the liquid dispenser apparatus, even at small quantities, the base structure may be also formed by a 3D-printed structure.

Depending on the desired manufacturing method of the base structure and the liquid dispenser apparatus in general, there are at least two alternatives for the basic design of the base structure. According to a first alternative, the base structure of the liquid dispenser apparatus may be a unitary molded structure. In this case, it is possible to insert parts of the liquid dispenser apparatus, such as parts of the valve arrangement or the like, into a molding tool and to overmold the base structure around the inserted parts via injection molding, for example.

According to a second alternative, it is also possible that the base structure is formed by multiple parts, in particular two or more than two parts. In this context, the base structure may comprises two structure halves, in particular two substantially identical or non-identical structure halves. Thus, the structure halves may be formed as two separated halves that may be configured to be separated by a parting plane. With the multiple parts or the structure halves being separated, it is possible to insert parts of the valve arrangement and optionally pipes forming the passage arrangement. Thereafter, the multiple parts or the structure halves may be combined and sealed against each other to ensure a fluid tight connection between the structure halves.

As already mentioned above, the liquid dispenser apparatus, according to the present invention, comprises the storage connecting portion which is designed and intended to be connected to a liquid storage. The storage connecting portion may comprise a connecting part, such as a connecting flange and/or a connecting pipe or the like, to connect the liquid dispenser apparatus with the liquid storage. At this point, it should be mentioned that the liquid storage is not necessarily part of the liquid dispenser apparatus according to the invention so that in principle the liquid dispenser apparatus may be connected to different types of liquid storages.

However, if a more compact design should be desired, according to a further embodiment, the liquid dispenser apparatus may further comprise a first liquid storage which is connected to the storage connecting portion and configured to store a first liquid, and/or a second liquid storage which is connected to the storage connecting portion and configured to store a second liquid. If the liquid dispenser apparatus comprises the first liquid storage and the second liquid storage, the storage connecting portion may comprise a first sub portion for the first liquid storage and a second sub portion for the second liquid storage. In this context, the first liquid may be different to second liquid, wherein the first liquid may be preferably cold or hot or boiling water or water at ambient temperature and/or the second liquid may preferably be sparkling water or the like.

If it is desired to store two or more kinds of, preferably different, liquids, the liquid dispenser apparatus may further comprise at least two liquid storages that are connected to the storage connecting portion.

To ensure a particularly compact design, the first liquid storage and the second may be configured such that they are arranged in an interleaved manner. For example, the first liquid storage may receive at least in part or entirely house the second liquid storage or vice versa. It goes without saying that such an interleaved arrangement of liquid storages is also possible in the case in which the liquid dispenser apparatus further comprises more than two liquid storages.

As already mentioned above, it is the merit of the inventors to have recognized that in order improve the reliability against potential leakage and to improve the ease of maintenance, the liquid dispenser apparatus should comprise as few liquid inlets and/or outlets as well as few transition or connection points of one component of the liquid dispenser apparatus to another component of the liquid dispenser apparatus as possible.

Thus, if the liquid apparatus comprises the first liquid storage and/or the second liquid storage, it is further proposed that the storage connecting portion is designed and intended to be inserted at least in part into the first and/or the second liquid storage, in particular through an opening of the first liquid storage and/or an opening of the second liquid storage. As a result, the opening(s) of the liquid storage(s) may be used for injecting liquid and/or gas into the liquid storage(s) and/or to remove it therefrom. If the storage connecting portion comprises the above mentioned connecting part including the connecting flange and/or the connecting pipe, for example, the connecting flange and/or the connecting pipe only have to be inserted into the opening of the respective liquid storage to an amount that enables fluid communication between the respective liquid storage and the storage connecting portion of the liquid dispenser apparatus.

In order to minimize the number of inlet and outlet openings of the liquid storage(s) and thus, the risk of potential leakage, it is particularly preferred that the first liquid storage and/or the second liquid storage comprises only one single opening, wherein the single opening is in particular the opening in which the storage connecting portion is inserted.

To enable precise liquid and/or gas injection into the liquid storage(s) and/or precise removal therefrom, it is further proposed that the liquid dispenser apparatus or the storage connecting portion may comprises a liquid injecting nozzle and/or a gas injecting nozzle. If it is further desired for the liquid dispenser apparatus to provide hot and/or cold liquid, such as hot and/or cold water, the liquid dispenser apparatus or the storage connecting portion may further comprises a heating device and/or a cooling device. Thus, the liquid injecting nozzle and/or the gas injecting nozzle and/or the heating device and/or the cooling device may be a part of or connected to the storage connecting portion or may be a part external to the storage connecting portion. It goes without saying that in the latter case, in order to control the operation of the heating device and/or the cooling device, the heating device and/or the cooling device may have a signal input connected to the at least one signal output of the control unit.

In principle, it may be sufficient for the liquid dispenser apparatus to provide the liquid delivered from the liquid source, such as the mains water supply, as well as liquid stored in the first liquid storage and/or the second liquid storage. However, if it is desired for the liquid dispenser apparatus to also provide a wider range of beverages, according to a further embodiment, the liquid dispenser apparatus may also comprise at least a third liquid storage which is connected to the base structure and configured to store a third type of liquid, preferably an additive, wherein preferably the third liquid storage is further connected to a pump which is configured to supply the third type of liquid into the passage arrangement. Furthermore, the liquid dispenser apparatus may also comprise further liquid storages which are connected to the base structure and configured to store further types of liquids, such as further additives. Likewise, the further liquid storages may be connected to respective pumps to supply the further types of liquids into the passage arrangement.

In addition or as an alternative, to be also able to prepare hot beverages, such as coffee and/or tea or the like, the liquid dispenser apparatus may also comprise a capsule loading device which is configured to be loaded with capsules containing an additive, such as powder, in particular coffee powder, or concentrated liquid. In this context the pump or an additional pump of the liquid dispenser apparatus may be operatively connected on the one hand to the first and/or the second liquid storage and on the other hand to the capsule loading device. The pump or the additional pump may be configured to draw liquid out of the first liquid storage and/or the second liquid storage and to supply the liquid to the capsule loading device for mixing it with the additive of a respective capsule, and via the capsule loading device to the passage arrangement or, in particular directly, to the liquid dispensing unit, such as the faucet.

The additive may be in particular a beverage additive, for example syrup and/or concentrated flavors and/or health liquids containing ingredients, such as vitamins and/or minerals, and/or a hot beverage additive, such as a concentrated liquid for tee or coffee. The pump and/or the additional pump may be arranged internal or external to the base structure and/or may comprise a signal input which may be connected to the at least one signal output of the control unit.

At this point it should be also mentioned, that the connection between the third liquid storage and the base structure may be realized by a part of the passage arrangement or a further passage that is separate to the passage arrangement. In the latter case of the further passage it is also possible to deliver the third liquid separately to the base structure and/or through the base structure, in particular directly to the liquid dispensing unit, such as the faucet.

If the liquid dispenser apparatus comprises the third liquid store, it may also be advantageous that the liquid dispenser apparatus further comprises a mixing device which is connected on the one hand to the passage arrangement and on the other hand to the third liquid storage, wherein the mixing device is configured to mix the third liquid stored in the third liquid storage with liquid originating from the first liquid storage and/or the second liquid storage and/or the liquid source and/or with gas from the gas source.

To also ensure appropriate and reliable control of the fluid passage of the liquid inlet and/or the gas inlet and/or the dispensing outlet and/or the storage connecting portion, the valve arrangement may comprise a solenoid valve and/or a check valve and/or a pressure relief valve and/or any mechanical or electromechanical part.

In addition or as an alternative, it is further proposed that the liquid dispenser apparatus further comprises a detecting device having a signal output which is connected to the at least one signal input of the control unit, wherein the detecting device is configured to detect a liquid or gas condition, such as a pressure and/or a temperature and/or a flow level and/or a liquid or gas level, in the passage arrangement and/or in a storage connected to the base structure. To detect the existence of any liquid storage, for example as an input information for the control unit, the detecting device may be also configured to detect whether a liquid storage, in particular the third liquid storage, is connected to the base structure or not.

If the liquid dispenser apparatus comprises the first and/or the second liquid storage, also the detecting device may be designed and intended to be inserted at least in part into the first and/or the second liquid storage through the opening of the first liquid storage and/or the opening of the second liquid storage. If inserted in both the opening of the first liquid storage and the opening of the second liquid storage, the detecting device may comprise a first detecting unit configured to be inserted at least in part into the first liquid storage and a second detecting unit configured to be inserted at least in part into the second liquid storage.

It should be added that the gas which is supplied to the gas inlet from the gas source may preferably comprise CO₂.

As generally known, water delivered by the mains water supply often contains high quantities of lime and/or other undesired substances that should be eliminated at least in part by the liquid dispenser apparatus. Thus, it is further proposed that the liquid dispenser apparatus comprises a filter arrangement which is connected to the liquid inlet and configured to filter the liquid delivered by the liquid source.

Preferably, the filter arrangement may be located upstream or downstream of the liquid inlet of the base structure.

In general the control unit may be disposed near or adjacent to the base structure so that is possible to connect the at least one signal output of the control unit with signal inputs of components, such as the valve arrangement, that are configured to be controlled by the control unit. In this context, to ensure an even more compact design of the whole apparatus is further proposed that the control unit is arranged in the base structure of the liquid dispenser apparatus.

It should be also added that the user interface of the liquid dispenser apparatus may comprise a control element, for example a rotary switch, a push switch, a touch screen or a combination thereof, wherein preferably the control element is arranged on or adjacent to the liquid dispensing unit.

Preferred embodiments of the present invention will now be described in more detail with respect to the accompanying drawings, in which:

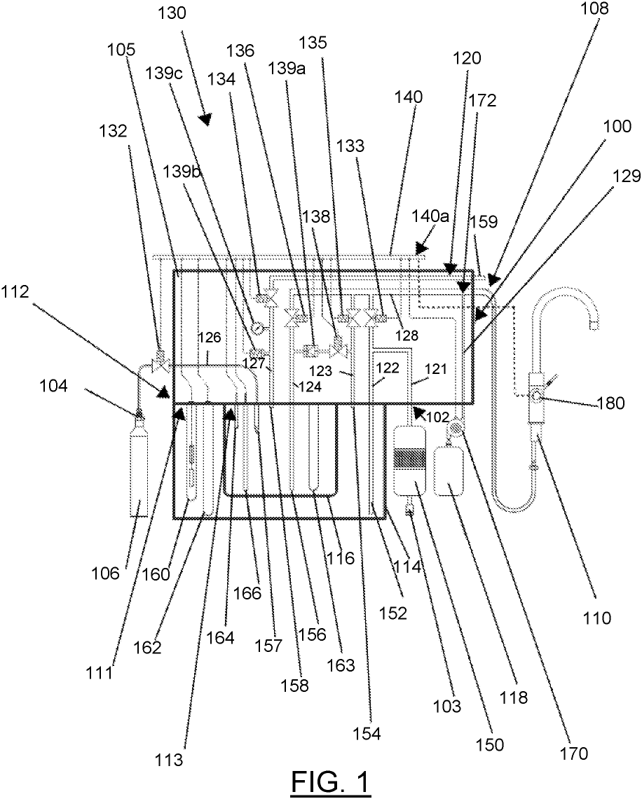

FIG. 1 is a schematic cross-sectional view of an embodiment of a liquid dispenser apparatus according to the present invention;

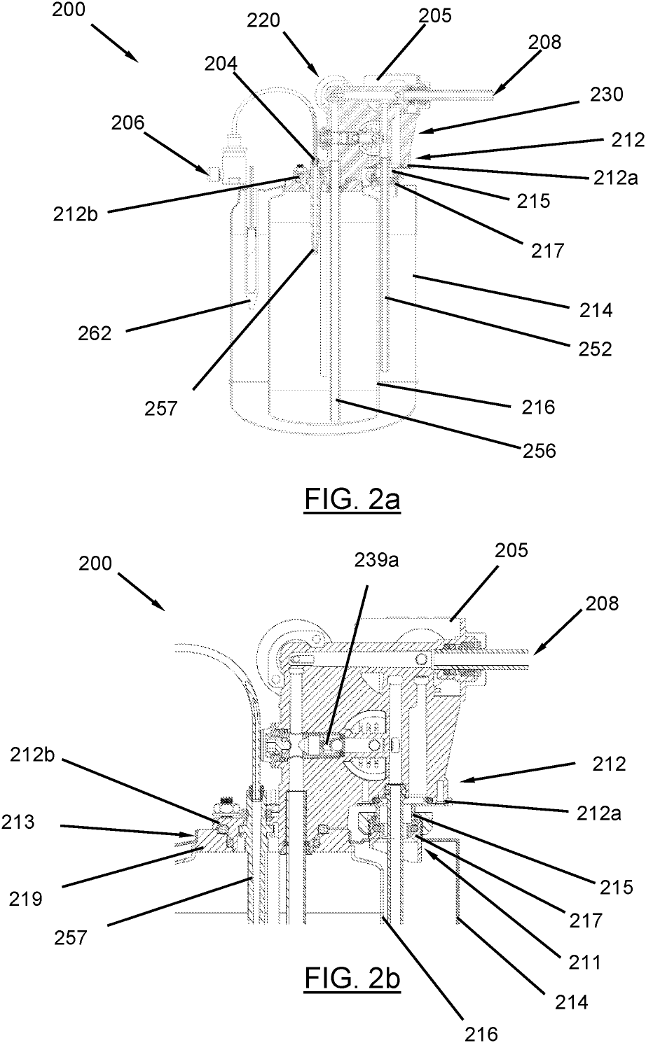

FIG. 2a is a more specific embodiment of the liquid dispenser apparatus shown in FIG. 1;

FIG. 2b is an enlarged view of the upper right part of FIG. 2a; and

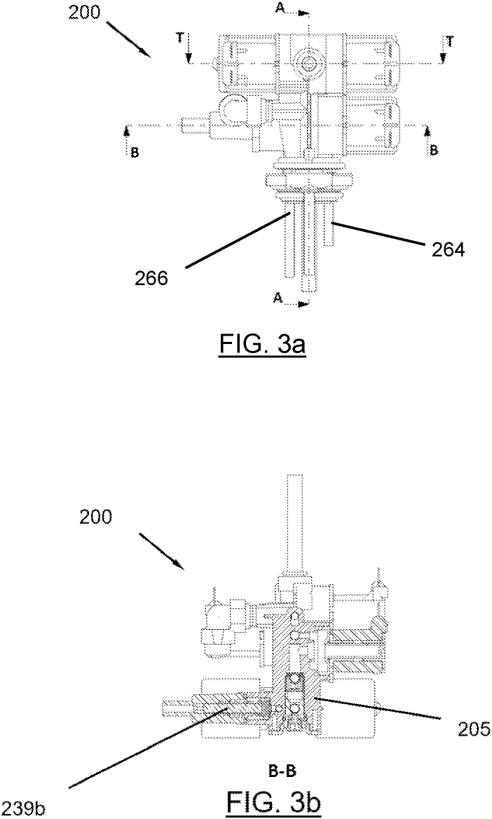

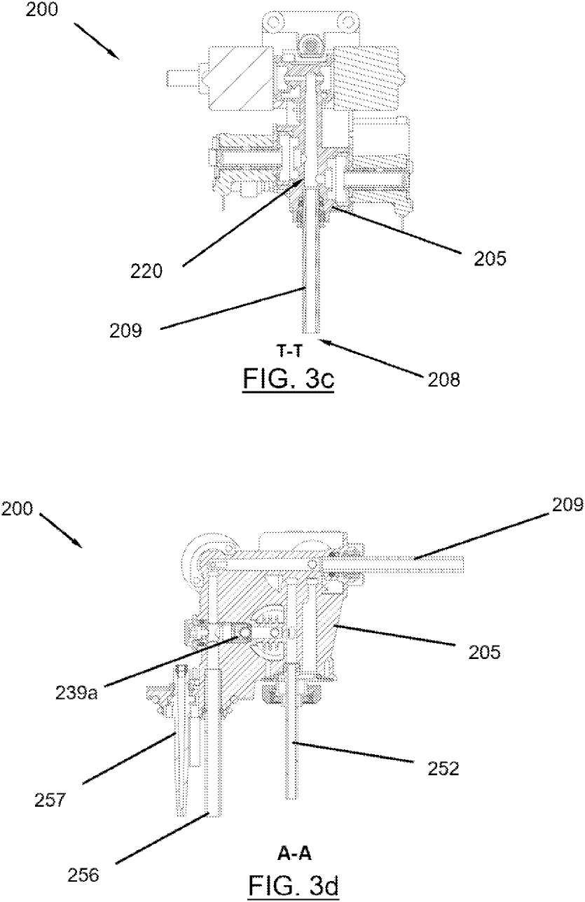

FIG. 3a shows a partial view of the liquid dispenser apparatus shown in FIG. 2a, and

FIGS. 3b to 3d show partial cross-sectional views derived from FIG. 3a of the liquid dispenser apparatus shown in FIG. 2a.

In FIG. 1a liquid dispenser apparatus according to an embodiment of the invention is generally denoted by the reference sign 100.

The liquid dispenser apparatus 100 comprises a liquid inlet 102 which is designed and intended to be connected to a liquid source 103 and to receive a liquid, for example water, from the liquid source 103. The liquid source may be a mains water supply or the like. As also shown in FIG. 1, the liquid dispenser apparatus 100 further comprises a gas inlet 104 which is designed and intended to be connected to a gas source 106, which, in the present embodiment, is a container for carbon dioxide (CO₂) gas. To be able to dispense liquid out of the liquid dispenser apparatus 100, the liquid dispenser apparatus 100 further includes a dispensing outlet 108 which, in the present embodiment, is connected to a liquid dispensing unit in the form of a faucet 110.

To enable the liquid dispenser apparatus to be connected to a liquid storage, the liquid dispenser apparatus according to the present embodiment further includes a storage connecting portion which is generally designated by reference sign 112. In the present embodiment, the storage connecting portion 112 is connected to a first liquid storage 114 which, in the present embodiment, is designed to contain chilled tap water, and to a second liquid storage 116 which is, in the present embodiment, configured to contain sparkling water. In the present embodiment, the liquid dispenser apparatus 100 further comprises a third liquid storage 118 configured to contain an additive for beverages, such as syrup and/or concentrated flavors and/or health liquids containing ingredients, such as vitamins and/or minerals.

To put the liquid inlet 102, the gas inlet 104, the dispensing outlet 108, and the storage connecting portion 112 into fluid communication with each other, the liquid dispenser apparatus further comprises a passage arrangement, which is generally designated by reference sign 120. Passages of the passage arrangement 120 are described in more detail below. To control the fluid passage of the liquid inlet 102, the gas inlet 104, the dispensing outlet 108, and the storage connecting portion 112, the liquid dispenser apparatus 100 further includes a valve arrangement, which in FIG. 1 is generally designated by reference sign 130.

To control the operation of the valve arrangement 130, the liquid dispenser apparatus 100 according to the present embodiment further comprises a control unit 140 which is merely indicated schematically in FIG. 1. The control unit 140 has at least one signal input 140a which is configured to be connected to a user interface 180 that is arranged near or on the faucet 110. Based on the signal input signal received from the user interface 180, the control unit 140 is configured to control a plurality of valves in form of solenoid valves of the valve arrangement 130, namely solenoid valves 132, 133, 134, 135, 136, and 138. To control each of said solenoid valves of the valve arrangement 130, the control unit 140 comprises a corresponding number of signal outputs, wherein each signal output is connected to a corresponding solenoid valve, as indicated by dotted lines in FIG. 1.

By operating the solenoid valves of the valve arrangement 130, it is possible to control a fluid passage within passages of the passage arrangement 120. In the embodiment shown in FIG. 1, the passage arrangement 120 comprises a liquid inlet passage 121 which is configured to supply tap water from the liquid inlet 102 originating from the liquid source. In the present embodiment, a filter 150 is arranged between the liquid source 103 and the liquid inlet 102. Via the liquid inlet passage 121, it is possible to introduce tap water into passage 121 and then via passage 122 and a pipe 152 into the first liquid storage 114.

To detect the current temperature of water contained in the first liquid storage 114, the liquid dispenser apparatus 100 according to the present embodiment further comprises a detecting device in form of a temperature sensor 160 which is connected to the storage connecting portion 112 and configured to be inserted into a first liquid storage 114 through an opening of the first liquid storage 114. Therefore, the temperature sensor 160 comprises at least one signal output that is connected to a signal input of the control unit 140 as indicated by the dotted line in FIG. 1. To condition the water contained in the first liquid storage 114 to a desired temperature, the liquid dispenser apparatus 100 further comprises a conditioning device 162, which may be a heating device or a cooling device or a combination thereof.

To be also able to fill the second liquid storage 116 with water, the passage arrangement 120 further comprises a passage 123 connected to a pipe 154 so that water may be delivered via pipe 154, passage 123 and a further passage 124 as well as a pipe 156 into the second liquid storage 116. The flow of liquid from the first liquid storage 114 to the second liquid storage 116 via pipe 154 and passages 123 and 124 as well as pipe 156 may be controlled via opening solenoid valve 138 of the valve arrangement 130. To ensure that liquid is able to flow from the first liquid storage 114 into the second liquid storage 116 but not from the second liquid storage 116 to the first liquid storage 114, the valve arrangement 130 further comprises a one-direction valve (check valve) 139a.

Similar to the first liquid storage 114, the second liquid storage 116 further comprises another conditioning device 163 which likewise may be a cooling device or a heating device or a combination thereof.

To add gas from the gas container 106, the passage arrangement 120 further comprises a passage 126 which is connected on the one end to the gas inlet 104 and on the other end to a nozzle 157 that is configured to be inserted into the second liquid storage 116 and to introduce gas in form of CO₂ from the gas container 106. To allow or interrupt the introduction of CO₂ into the second liquid container 116, the valve arrangement 130 comprises the solenoid valve 132 that is connected between the passage 126 and the gas inlet 104.

To monitor a liquid level in the second liquid storage 116, the second liquid storage 116 comprises a first water level sensor 164 as well as a second water level sensor 166 to detect an upper liquid level and a lower liquid level, respectively, in the second liquid storage 116. Therefore, the signal outputs of the first water level sensor 164 and the second water level sensor 166 are connected to corresponding signal inputs of the control unit 140, as indicated by dotted lines in FIG. 1. The signal input of the first water level sensor 164 and the second water level sensor 166 may be used by the control unit 140 to, in particular automatically, determine and execute whether or not to deliver water from the first liquid storage 114 into the second liquid storage 116 via operating valve 138 and to deliver CO₂ gas via passage 126 by operating solenoid valve 132. Furthermore, sparkling water may be also prepared, in particular automatically, when the control unit 140 receives a signal input via the user interface 180 and the signal input 140a of the control unit 140.

To ensure that a pressure present in the second liquid storage 116, which is filled with sparkling water, does not exceed a predetermined threshold pressure, the second liquid storage 116 is further connected to a pressure relief valve 139b that is configured to transition into an open state if the pressure present in the second liquid storage 116 exceeds the predetermined threshold pressure. Therefore, the pressure relief valve 139b is connected to the second liquid storage 116 via passage 127 and pipe 158 that is inserted into the second liquid storage 116. A signal output of the pressure relief valve 139b is also connected to a signal input of the control unit 140, as indicated by a corresponding dotted line.

To further control the pressure that is present in the second liquid storage 116, the liquid dispenser apparatus 100 further comprises a pressure gauge 139c.

To be able to release pressure from the second liquid storage 116 not only when the pressure exceeds the predetermined threshold pressure but also to release gas, such as air, when the second liquid storage 116 is filled with liquid or whenever it is desired, the valve arrangement 130 further comprises the solenoid valve 134 having a signal input that is connected to a signal output of the control unit 140, as indicated by corresponding dotted line in FIG. 1. Thus, it is possible to release gas from the second liquid storage 116 by opening the solenoid valve 134 via passage 127 and an air outlet pipe 159.

As already mentioned above, the liquid dispenser apparatus 100 further comprises a third liquid storage 118 containing an additive. To be able to deliver the additive into the liquid dispenser apparatus 100, the liquid dispenser apparatus 100 may further comprise a pump 170. As indicated by a dotted line, also the pump may comprise a signal input that is connected to a signal output of the control unit 140.

Thus, with the above-described arrangement, it is possible to deliver non-sparkling hot or cold water or water at ambient temperature from the first liquid storage 114 via pipe 154 and passage 123 by opening solenoid valve 135 such that the water flows through passage 128 and dispensing outlet 108 towards the faucet 110.

In addition, it is possible to deliver sparkling water via pipe 156 and passages 124, 128 via opening valve 136, with the other valves of the valve arrangement 130 being closed. Irrespective of whether the liquid dispenser apparatus 100 provides water from the first liquid storage 114 or water from the second liquid storage 116, it is also possible to additionally or alternatively provide an additive from the third liquid storage 118 via operating the pump 170 that is configured to deliver the additive through passage 129 into passage 128 and, thus, via the dispensing outlet 108 towards the faucet 110.

To mix water originating from the first liquid storage 114 and/or water originating from the second liquid storage 116 at the connection point between passage 128 and passage 129, a mixing device may be provided, that is indicated by reference sign 172 and is configured to mix the additive from the third liquid storage 118 with liquid originating from the first liquid storage 114 and/or the second liquid storage 116.

FIGS. 2a and 2b show cross-sectional views of a more specific embodiment of a liquid dispenser apparatus 200 that with regard to its general functionality corresponds to the schematic embodiment of the liquid dispenser apparatus 100 in FIG. 1.

In FIGS. 2a and 2b the liquid dispenser apparatus 200 comprises a base structure 205 that is, in this embodiment, formed by an injection-molded structure. The liquid dispenser apparatus 200 also includes a passage arrangement 220 including a plurality of passages that are formed in the base structure 205.

The liquid dispenser apparatus 200 further comprises a storage connecting portion 212 for connecting to a first liquid storage 214 and a second liquid storage 216.

The first liquid storage 214 and the second liquid storage 216 are interleaved with each other, wherein the first liquid storage 214 houses the second liquid storage 216.

In the present embodiment, the storage connecting portion 212 comprises a first storage connecting sub portion 212a that is formed in the base structure 205 and connected to the first liquid storage 214. Between the storage connecting sub portion 212a and the first liquid storage 214 a metal part in form of a metal flange 215 is inserted. To connect the metal flange 215 with the first liquid storage 214, the first liquid storage 214 further comprises a corresponding flange 217 that is screwed together with the metal flange 215. The storage connecting portion 212 further comprises a second storage connecting sub portion 212b that is likewise formed in the base structure 205 and connected to the second liquid storage 216. Different to the first storage connecting sub portion 212a, the second storage connecting sub portion 212b is formed in a flange shape so that it is suitable to be directly connected to a corresponding storage connecting portion receiving part 219 formed in the second liquid storage 216.

Pipes 252 and 256 are inserted into the first liquid storage 214 and the second liquid storage 216, respectively, and connected to the storage connecting portion 212 of the liquid dispenser apparatus 200 to introduce liquid into the first liquid storage 214 and the second liquid storage 216, respectively, and/or to remove it therefrom. Liquid may be delivered to a liquid outlet 208 via the passage arrangement 220 and controlled by valves of a valve arrangement 230 that operates similar to the valve arrangement 130 described with reference to FIG. 1.

A gas injecting nozzle 257 is inserted into the second liquid storage 216 to introduce gas in form of CO₂ into the second liquid storage 216. Therefore, the gas injecting nozzle 257 is connected to a gas source 206 via a gas inlet 204.

To adapt the temperature of liquid, in particular of water, contained in the first liquid storage 214, and optionally in the second liquid storage 216, a conditioning device 262 that is configured to heat and/or cool liquid is inserted into the first liquid storage 214.

It should be added, that the valves of the valve arrangement 230, such as a one direction valve (check valve) 239a, and the conditioning device 262 are all connected to a control unit (not shown in FIGS. 2a and 2b) that operates similar to the control unit 140 shown in FIG. 1.

FIG. 3a shows a partial view of the liquid dispenser apparatus 200 shown in FIG. 2a. As shown in FIG. 3a, the liquid dispenser apparatus 200 comprises first and second liquid water level sensors 264 and 266, operating similar to the first water level sensor 164 and the second water level sensor 166.

FIGS. 3b to 3d show partial cross-sectional views derived from FIG. 3a of the liquid dispenser apparatus 200 shown in FIG. 2a.

FIG. 3b shows a pressure relieve valve 239b which is arranged in the base structure 205 and operates similar to the pressure relieve valve 139b described with reference to FIG. 1.

FIG. 3c, in turn, shows an outlet pipe 209 of the liquid outlet 208 which is connected to the passage arrangement 220 and intended to be connected to a faucet (not shown).

FIG. 3d is a further sectional view showing the one direction valve (check valve) 239a. FIG. 3d further shows the passage 256 for introducing liquid into the second liquid storage 216 and/or to remove it therefrom, the passage 252 for introducing liquid into the first liquid storage 214 and/or to remove it therefrom, and the gas injecting nozzle 257.

1. A liquid dispenser apparatus, comprising
a base structure having:
a liquid inlet connected to a liquid source and configured to receive a liquid from the liquid source;
a gas inlet connected to a gas source and configured to receive gas from the gas source;
a dispensing outlet connected to a liquid dispensing unit;
a storage connecting portion connected to a liquid storage; and
a passage arrangement is configured to put at least two of the liquid inlet, the gas inlet the dispensing outlet or the storage connecting portion into fluid communication with each other,
wherein the liquid dispenser apparatus further comprises:
a valve arrangement is seated in the base structure and configured to control a fluid passage of at least one of the liquid inlet, the gas inlet, the dispensing outlet, or the storage connecting portion, and
a control unit having at least one signal input be connected to a user interface, and at least one signal output connected to the valve arrangement and configured to control the valve arrangement by the at least one signal output, and
wherein the base structure of the liquid dispenser apparatus is formed by a molded structure or by a machined structure.

2. The liquid dispenser apparatus according to claim 1, wherein the base structure of the liquid dispenser apparatus is formed by an injection molded structure or by a 3D-printed structure.

3. The liquid dispenser apparatus according to claim 1, wherein the base structure of the liquid dispenser apparatus is a unitary molded structure.

4. The liquid dispenser apparatus according to claim 1, further comprising:
a first liquid storage is connected to the storage connecting portion and configured to store a first liquid; and
a second liquid storage is connected to the storage connecting portion and configured to store a second liquid.

5. The liquid dispenser apparatus according to claim 4, wherein the storage connecting portion configured to be inserted at least in one of:
an opening of the first liquid storage or
an opening of the second liquid storage.

6. (canceled)

7. The liquid dispenser apparatus according to claim 1 wherein the storage connecting portion further comprises:
a liquid injecting pipe;
a gas injecting nozzle; and
at least one of a heating device or a cooling device.

8. The liquid dispenser apparatus according to claim 4 further comprising a third liquid storage is connected to the base structure and configured to store a third liquid,
wherein the third liquid storage is further connected to a pump which is configured to supply the third liquid out of the third liquid storage into the passage arrangement or to the liquid dispensing unit.

9. The liquid dispenser apparatus according claim 8, further comprising a mixing device is connected to the passage arrangement and to the third liquid storage wherein the mixing device is configured to mix the third liquid stored in the third liquid storage with at least one of the first liquid from the first liquid storage the second liquid from the second liquid storage the liquid from the liquid source, or the gas from the gas source.

10. The liquid dispenser apparatus according to claim 1, wherein the valve arrangement comprises a solenoid value, a check valve, or a pressure relief valve.

11. The liquid dispenser apparatus according to claim 8, further comprising a detecting device having a signal output which is connected to the at least one signal input of the control unit, wherein the detecting device is configured to detect a liquid or gas condition a in at least one of the passage arrangement or a storage connected to the base structure.

12. The liquid dispenser apparatus according to claim 11, wherein the detecting device is configured to be inserted at least in part into the first liquid storage through the opening of the first liquid storage.

13. The liquid dispenser apparatus according to claim 1, wherein the gas is supplied to the gas inlet from the gas source is CO₂ gas.

14. The liquid dispenser apparatus according to claim 1, further comprising a filter arrangement is connected to the liquid inlet and configured to filter the liquid delivered by the liquid source.

15. The liquid dispenser apparatus according to claim 1, wherein the control unit is arranged in the base structure of the liquid dispenser apparatus.

16. The liquid dispenser apparatus according to claim 1, wherein the base structure of the liquid dispenser apparatus is formed by multiple parts.

17. The liquid dispenser apparatus according to claim 4, further comprising a capsule loading device which is configured to be loaded with capsules containing an additive, wherein the capsule loading device is further connected to a pump configured to supply the first liquid originating from the first liquid storage or the second liquid originating from the second liquid storage through the capsule loading device into the passage arrangement or to the liquid dispensing unit.

18. The liquid dispenser apparatus according to claim 4, further comprising a detecting device having a signal output which is connected to the at least one signal input of the control unit, wherein the detecting device is configured to detect whether a third liquid storage is connected to the base structure or not.

19. The liquid dispenser apparatus according to claim 11, wherein the detecting device is configured to be inserted at least in part into the second liquid storage through the opening of the second liquid storage.

20. The liquid dispenser apparatus according to claim 11, wherein the gas condition or the liquid condition includes one or more of a pressure, a temperature, a flow level, a liquid level, and a gas level.

21. The liquid dispenser apparatus according to claim 1, further comprising a first liquid storage connected to the storage connecting portion and configured to store a first liquid.
